(19) United States
(12) Patent Application Publication
(10) Pub. No.: US 2011/0267935 A1
(43) Pub. Date: Nov. 3, 2011

(54) OPTICAL PICKUP DEVICE

(75) Inventor: Hideo YASUMOTO, Osaka (JP)

(73) Assignee: PANASONIC CORPORATION, Osaka (JP)

(21) Appl. No.: 12/975,350

(22) Filed: Dec. 21, 2010

(30) Foreign Application Priority Data
Dec. 24, 2009 (JP) 2009-291712

(51) Int. Cl. G11B 7/00

(52) U.S. Cl. 369/112.23; G9B/7.121

(57) ABSTRACT

An optical pickup which is configured to suppress resonances in the objective lens which are caused during tilt control of the objective lens is provided. The optical pickup device includes an objective lens, a lens holder for retaining the objective lens, and an actuator for rotating the lens holder to control tilt of the objective lens. The objective lens is bonded to the lens holder via adhesives applied at a plurality of adhesion positions. The adhesion positions at which the objective lens and the lens holder are bonded are asymmetrical relative to a plane which includes the rotation axis of the lens holder and the optical axis of each objective lens.

### CROSS REFERENCE TO RELATED APPLICATION

The disclosure of Japanese Patent Application No. 2009-291712, filed on Dec. 24, 2009, is incorporated herein by reference.

### BACKGROUND OF THE INVENTION

1. Field of the Invention

The present invention relates to optical pickup devices which are configured to control tilt of objective lenses.

2. Description of the Background Art

In optical disk drives having a high data transfer rate, it is required to increase the high-order resonance frequency of the drive mechanism for driving objective lenses in order to widen the control band. Japanese Laid-Open Patent Publication No. 2004-164710 discloses a technique of reducing resonance transmitted from a lens holder to an objective lens. According to Japanese Laid-Open Patent Publication No. 2004-164710, in order to suppress a peak in a frequency characteristic of a high order resonance without forming a lens holder equipped with an objective lens in a particular structure, adhesives to bond the objective lens to the lens holder are applied to positions which are least likely to be deformed by the high order resonance.

In general, in order that optical pickup devices may control tilt of the objective lens, the lens holder is supported in such a manner as to freely rotate about a predetermined rotation axis. When the lens holder is driven to rotate, vibration occurs which depends on the material and shape of the lens holder. Accordingly, resonance at a frequency higher than the frequency used to drive the lens holder occurs in the objective lens.

An object of the present invention is to provide an optical pickup device which is configured to reduce resonance occurring in the objective lens upon tilt control of the objective lens.

### SUMMARY OF THE INVENTION

The present invention relates to an optical pickup device including: an objective lens; a lens holder for retaining the objective lens; and an actuator for rotating the lens holder to control tilt of the objective lens. The objective lens is bonded to the lens holder via adhesives applied at a plurality of adhesion positions. The adhesion positions at which the objective lens and the lens holder are bonded are asymmetrical relative to a plane which includes the rotation axis of the lens holder and the optical axis of the objective lens.

The lens holder may have a plurality of protrusions which are arranged asymmetrically relative to the plane including the rotation axis of the lens holder and the optical axis of the objective lens, and are in contact with the periphery of the lower surface of the objective lens. The objective lens is bonded to the lens holder by means of the adhesives while being supported by the protrusions.

According to the present invention, it is possible to reduce influence of vibration on the objective lens, which is caused by rotational drive of the lens holder.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an optical pickup device according to an embodiment;

FIG. 2 is a perspective view of a lens actuator illustrated in FIG. 1;

FIG. 3 is a partially enlarged view of the lens actuator illustrated in FIG. 2;

FIG. 4 is a top view of the lens actuator illustrated in FIG. 3;

FIG. 5A is a sectional view along a line V-V indicated in FIG. 4;

FIG. 5B is a top view of a part of a lens holder illustrated in FIG. 5A;

FIG. 6A is a sectional view along a line VI-VI indicated in FIG. 4;

FIG. 6B is a top view of a part of the lens holder illustrated in FIG. 6A;

FIG. 7A is a diagram illustrating a relation between adhesion positions and rotation of the lens holder according to an embodiment;

FIG. 7B is a sectional view along a line VII-VII indicated in FIG. 7A;

FIG. 8 is a perspective view of an optical pickup according to a comparative example;

FIG. 9 is an enlarged top view of a lens actuator illustrated in FIG. 8;

FIG. 10A is a diagram illustrating a relation between adhesion positions and rotation of a lens holder according to the comparative example; and

FIG. 10B is a sectional view along a line X-X indicated in FIG. 10A.

### DESCRIPTION OF THE PREFERRED EMBODIMENTS

<1. Structure of optical pickup device>

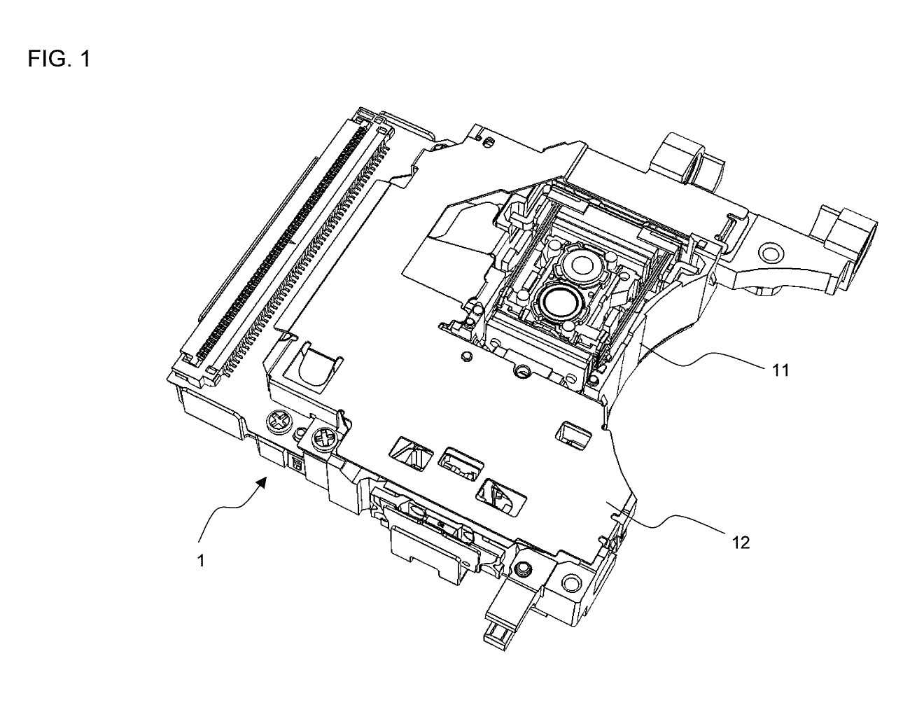

FIG. 1 is a perspective view of an optical pickup device according to an embodiment.

An optical pickup 1 is mounted in an optical disk drive, and performs at least one of reading information recorded on an optical disc, recording information onto an optical disc, and deleting information recorded on an optical disc. The optical pickup device 1 includes an optical base 12, and a lens actuator 11 fitted in the optical base 12. A semiconductor laser, a laser driving IC, a photodetector IC, and other optical components, which are not shown, are also fitted in the optical base 12.

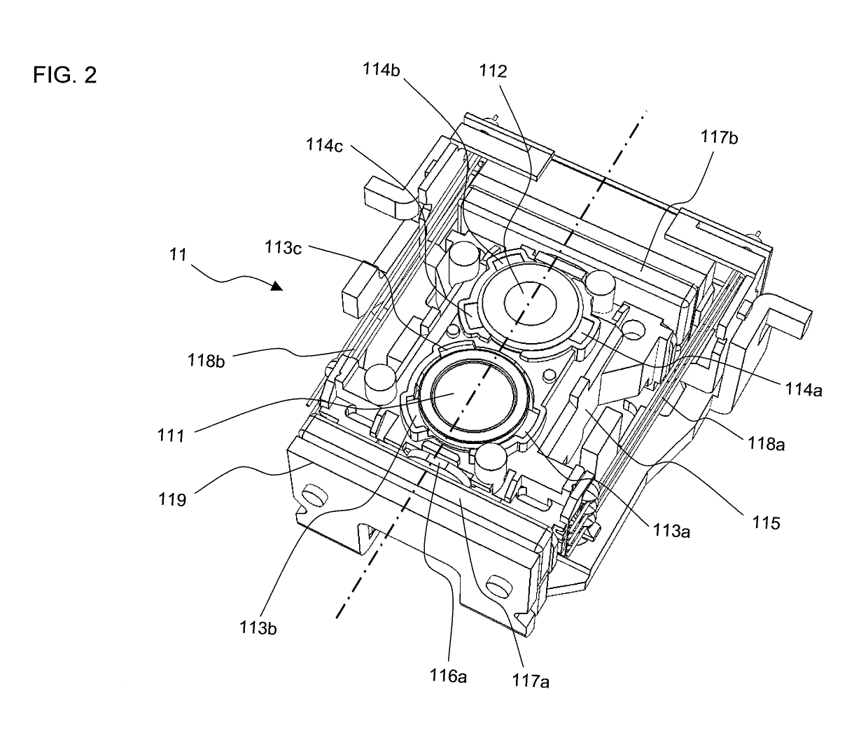

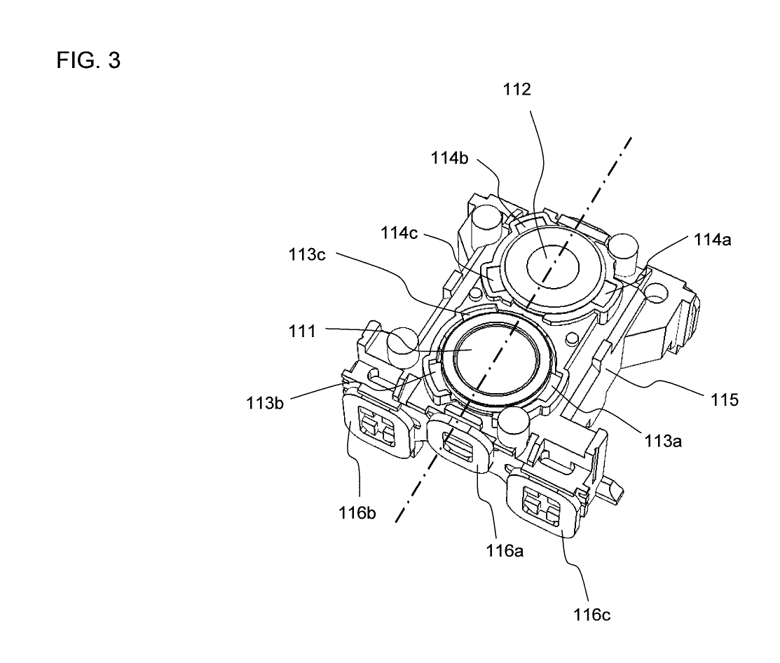

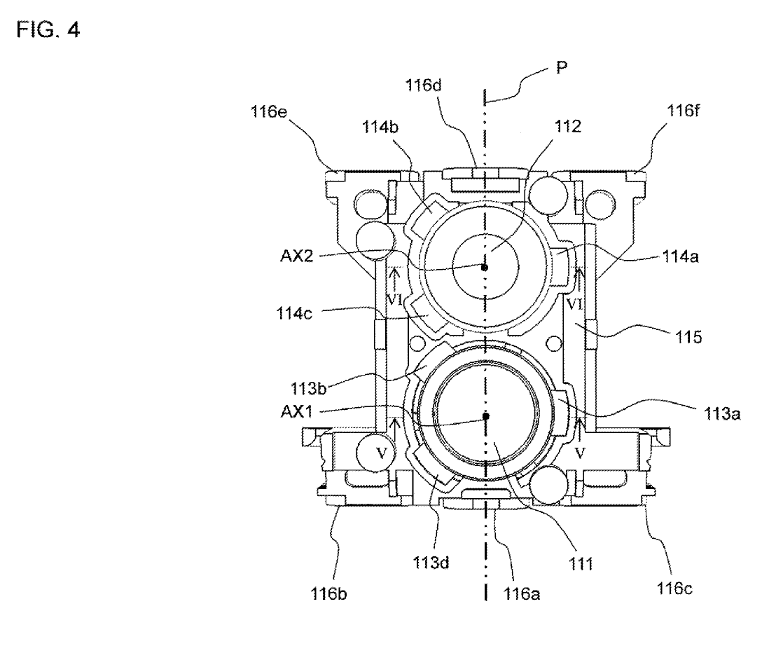

FIG. 2 is a perspective view of the lens actuator illustrated in FIG. 1. FIG. 3 is a partially enlarged view of the lens actuator illustrated in FIG. 2. And FIG. 4 is a top view of the lens actuator illustrated in FIG. 3.

The lens actuator 11 includes a DVD/CD objective lens 111, a BD objective lens 112, a lens holder 115, coils 116a to 116f, magnets 117a and 117b, wires 118a and 118b, and an actuator base 119.

The objective lens 111 is a lens compatible to be adaptable to light having a DVD wavelength and light having a CD wavelength. The objective lens 112 is a lens exclusively used for converging light having a BD wavelength. Both of the objective lenses 111 and 112 may be made of resin material or glass material.

The lens holder 115 is a member to retain the objective lenses 111 and 112. To control the tilt of the objective lenses 111 and 112, the lens holder 115 is supported in such a manner as to freely rotate about a predetermined rotation axis indicated by a dashed-dotted line in FIGS. 2 and 3. The objective lenses 111 and 112 are arranged in line along the rotation axis of the lens holder 115, and accommodated in a recessed portion formed in the lens holder 115. The objective lens 111 is bonded to the lens holder 115 by means of adhesives 113a to 113c, and the objective lens 112 is bonded to the lens holder 115 by means of adhesives 114a to 114c. How the objective lenses 111 and 112 are bonded to the lens holder 115 will be described later in detail.

The lens holder 115 is formed of, for example, resin material. As illustrated in FIG. 4, the lens holder 115 is formed in a substantially rectangular shape, where the direction along which the objective lenses 111 and 112 are aligned is set as the longitudinal direction. That is, the lens holder 115 is formed to have a shape corresponding to the arrangement of the objective lenses 111 and 112, and thereby reduction in size and weight of the lens holder 115 can be realized. In addition, since the longitudinal direction of the lens holder 115 corresponds to the rotation axis direction thereof, distortion of the lens holder 115 when it is rotationally driven can be suppressed, and consequently the objective lenses 111 and 112 can be less influenced by vibration.

The coils 116a to 116f are used to drive the lens holder 115. As illustrated in FIG. 4, the coils 116a to 116c are fitted on one of a pair of side surfaces of the lens holder 115 which intersect the rotation axis of the lens holder 115, and the coils 116d to 116f are fitted on the other one of the pair of side surfaces intersecting the rotation axis.

The actuator base 119 is a member for retaining the lens holder 115 and the magnets 117a and 117b. The lens holder 115 is fitted to the actuator base 119 via the wires 118a and 118b which are formed of metal springs. The magnet 117a is fixed to face the coils 116a to 116c, whereas the magnet 117b is fixed to face the coils 116d to 116f. The actuator base 119 may be formed of, for example, metal. The actuator base 119 is fixed to the optical base 12 illustrated in FIG. 1 by means of adhesives.

When current is fed to the coils 116a to 116b, the lens holder 115 is driven, due to the magnetism of the magnets 117a and 117b, in the rotational direction about the rotation axis, in a direction parallel to the optical axis, and in a direction perpendicular to the rotation axis. Such interaction between the coils 116a to 116f and the magnets 117a and 117b activates tilt control, focus control, and tracking control of the objective lens 111 and the objective lens 112. The rotation axis of the lens holder 115 which is the center of rotation for tilt control is determined according to the positions of the wires 118, the positions of the coils 116, the position of the center of gravity of the lens holder 115, and the like.

<2. Fitting of objective lens to lens holder>

Hereinafter, how the objective lenses 111 and 112 are bonded to the lens holder 115 will be described in detail.

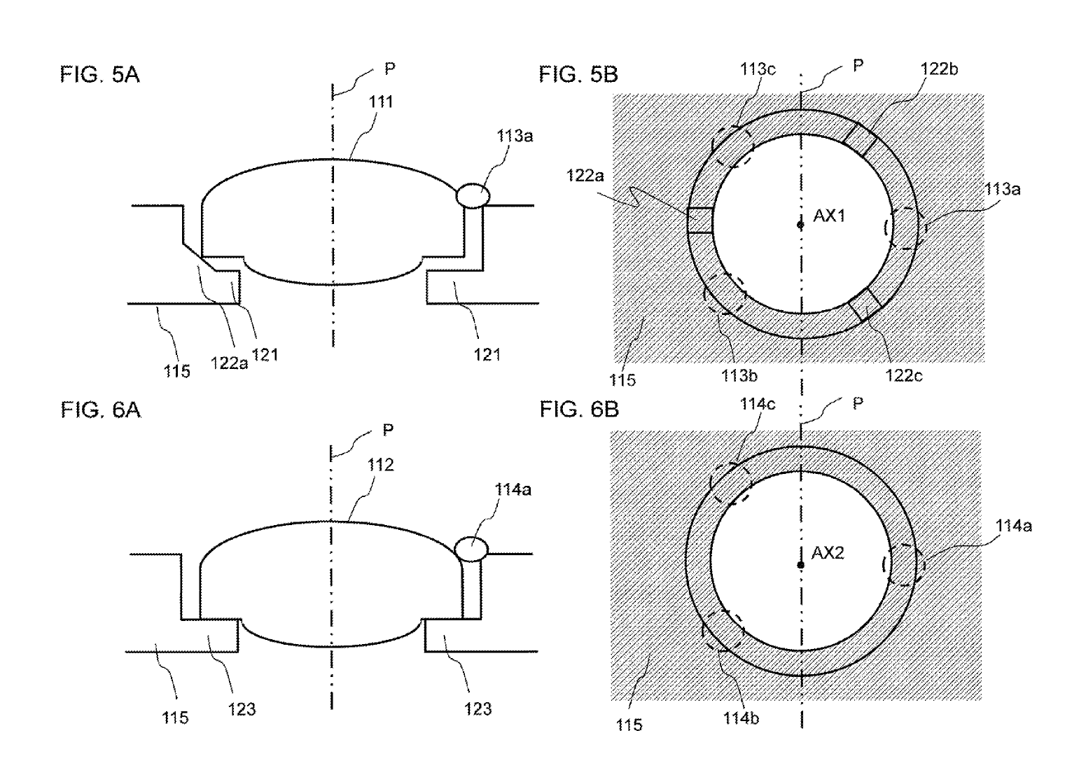

FIG. 5A is a sectional view along a line V-V indicated in FIG. 4, and FIG. 5B is a top view of a part of the lens holder illustrated in FIG. 5A.

A recessed portion which accommodates the objective lens 111 has an opening for allowing light to pass therethrough, and a support portion 121 which is arranged to surround the opening supports the periphery of the lower surface of the objective lens 111. More specifically, protrusions 122a to 122c are arranged on the upper surface of the support portion 121, and the protrusions 122a to 122c are in contact with the periphery of the lower surface of the objective lens 111. The protrusions 122a to 122c are arranged asymmetrically relative to a plane P which includes the rotation axis of the lens holder 115 and the optical axis AX1 of the objective lens 111. In this embodiment, the protrusions 122a to 122c are arranged at regular intervals in the circumferential direction of the objective lens 111.

The position of the objective lens 111 supported by the protrusions 122a to 122c is finely adjusted, and then the objective lens 111 is fixed to the lens holder 115 by means of the adhesives 113a to 113c poured into the space between the objective lens 111 and the recessed portion of the lens holder 115. A plurality of adhesion positions between the objective lens 111 and the lens holder 115 are arranged asymmetrically relative to the plane P including the rotation axis of the lens holder 115 and the optical axis AX1 of the objective lens 111. Further, the plurality of adhesion positions between the objective lens 111 and the lens holder 115 are arranged at regular intervals in the circumferential direction of the objective lens 111.

The number of protrusions 122a to 122c supporting the objective lens 111 is preferably an odd number, and more preferably three. This is because the fewer the number of protrusions is, the less the objective lens 111 is influenced by the vibration of the lens holder 115. It should be noted that as long as the plurality of protrusions which support the objective lens 111 are arranged asymmetrically relative to the plane P, the number of protrusions may be either an odd number or an even number.

FIG. 6A is a sectional view along a line VI-VI indicated in FIG. 4, and FIG. 6B is a top view of a part of the lens holder illustrated in FIG. 6A.

As illustrated in FIG. 6A, as compared to the objective lens 111 which is supported by the three protrusions 122a to 122c, the periphery of the lower surface of the objective lens 112 is supported by a surface. Specifically, a recessed portion which accommodates the objective lens 112 has an opening for allowing light to pass therethrough, and the upper surface of a support portion 123 which is arranged to surround the opening is in contact with the periphery of the lower surface of the objective lens 112.

Similarly to the bonding of the objective lens 111, the position of the objective lens 112 placed on the support portion 123 is finely adjusted, and then the objective lens 112 is fixed to the lens holder 115 by means of the adhesives 114a to 114c poured into the space between the objective lens 112 and the recessed portion of the lens holder 115. A plurality of adhesion positions between the objective lens 112 and the lens holder 115 are arranged asymmetrically relative to the plane P including the rotation axis of the lens holder 115 and the optical axis AX2 of the objective lens 112. The plurality of adhesion positions between the objective lens 112 and the lens holder 115 are arranged at regular intervals in the circumferential direction of the objective lens 112.

The BD objective lens 112 is supported by a plane surface, and the DVD/CD objective lens 111 is supported by points. This is because the objective lens 112 which needs to be bonded with high accuracy is firstly bonded to the lens holder 115, and the objective lens 111 is then fitted, so that the inclination of the objective lens 111 can be adjusted easily.

The number of adhesion positions between the objective lens 111 and the lens holder 115 is preferably an odd number, and more preferably three. This is because the fewer the number of adhesion positions is, the less the objective lens 111 is influenced by the vibration of the lens holder 115. Likewise, the number of adhesion positions between the objective lens 112 and the lens holder 115 is preferably an odd number, and more preferably three. It should be noted that as long as the plurality of adhesion positions between the objective lens 111 (objective lens 112) and the lens holder 115 are arranged asymmetrically relative to the plane P, the number of the adhesion positions may be either an odd number or an even number.

As described in this embodiment, the plurality of adhesion positions between the objective lens 111 and the lens holder 115 are preferably arranged at regular intervals in the circumferential direction of the objective lens 111. In this case, the inclination of the objective lens 111 caused by stress of the adhesives 113a to 113c can be reduced. Likewise, the plurality of adhesion positions between the objective lens 112 and the lens holder 115 are preferably arranged at regular intervals in the circumferential direction of the objective lens 112.

<3. Resonance suppression in optical pickup device according to this embodiment>

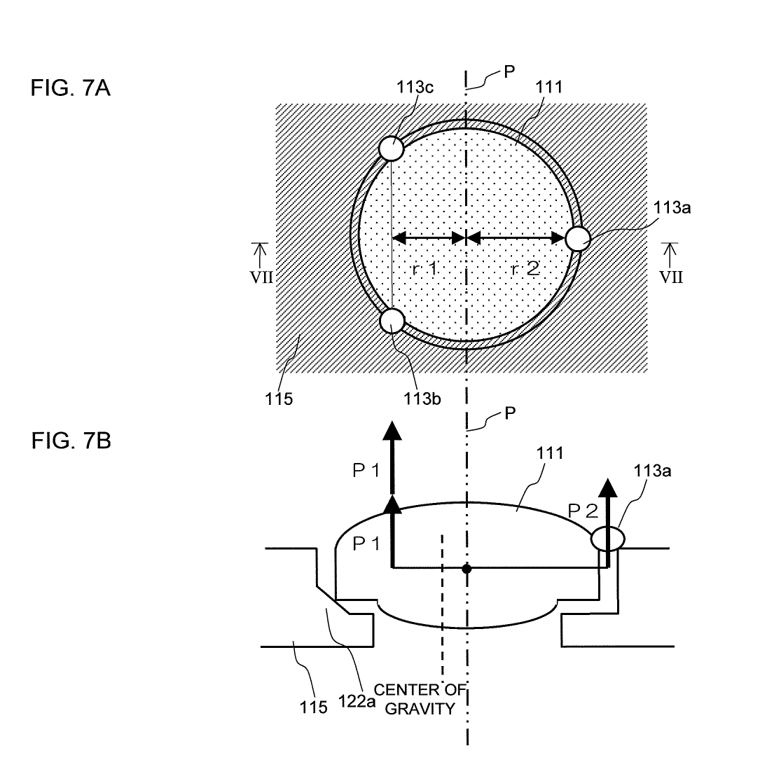

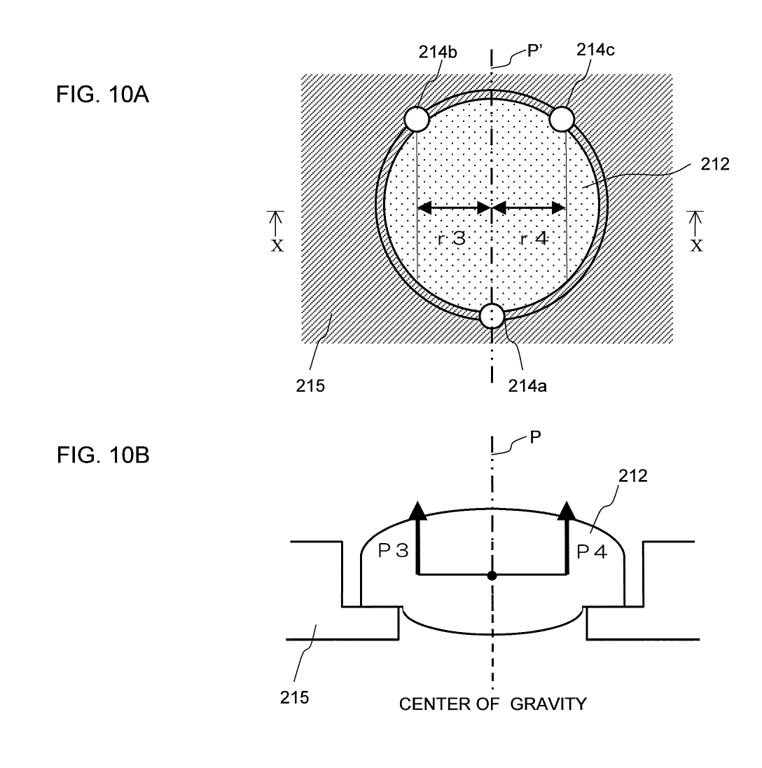

Hereinafter, the manner by which resonance is suppressed in the optical pickup device according to this embodiment will be described. For the sake of easy understanding of the present invention, description will be made by comparing this embodiment to a comparative example. With reference to FIGS. 7A, 7B, 10A, and 10B, torque is represented using distances between the plane P or P′ and points where adhesives are applied to, for simple explanation. Technically, however, the torque is represented by the distance between the rotation axis of the lens holder 115 and each adhesive.

The lens holder vibrates depending on the material and shape thereof. Distortion, deflection, and the like are considered as factors contributing to the vibration of the lens holder. The vibration of the lens holder reaches the objective lenses. The inventor of the present invention found that if the vibrational frequency of the lens holder is proximate to the vibrational frequency of the objective lenses, the vibrational amplitude of the objective lenses will increase. If the objective lenses vibrate, the optical axis of light having passed through each objective lens will vary, or the spot diameter of the light will vary, for example. When the optical axis or the spot system varies, noises will occur in detection signals used for tilt control, focus control, and tracking control by the lens holder. Consequently, accuracy in controlling the optical pickup device deteriorates.

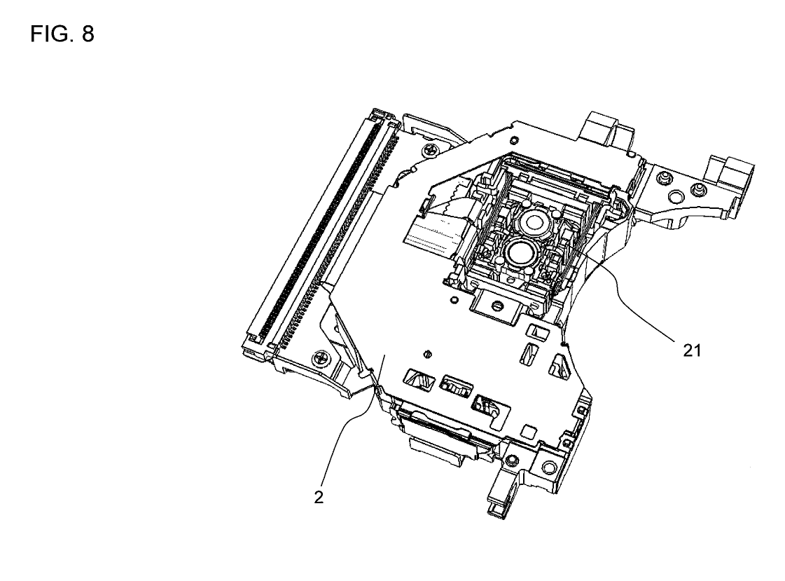

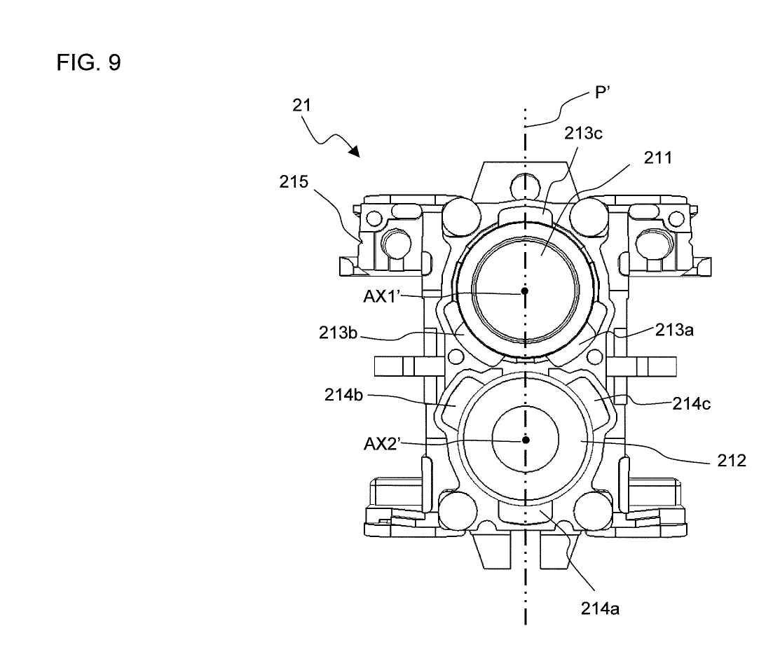

FIG. 8 is a perspective view of an optical pickup device according to a comparative example, and FIG. 9 is an enlarged top view of a lens actuator illustrated in FIG. 8.

A lens actuator 21 according to the comparative example is different from the actuator 11 according to this embodiment in that, in the lens actuator 21, arrangement of adhesives 213a to 213c for bonding a DVD/CD objective lens 211 to a lens holder 215, and arrangement of adhesives 214a to 214c for bonding a BD objective lens 212 to the lens holder 215 are different from those in this embodiment. As illustrated in FIG. 9, the adhesives 213a to 213c are applied to positions which are symmetrical relative to the plane P′ which includes the rotation axis of the lens holder 215, the optical axis AX1′ of the objective lens 211, and the optical axis AX2′ of the objective lens 212. Likewise, the adhesives 214a to 214c are applied to positions which are symmetrical relative to the plane P′.

FIG. 10A is a diagram illustrating the relation between adhesion positions and rotation of the lens holder according to the comparative example, and FIG. 10B is a sectional view along a line X-X indicated in FIG. 10A.

As illustrated in FIG. 10A, if the positions to which the adhesives 214a to 214b are applied are symmetrical relative to the plane P′ which includes the rotation axis of the lens holder 215 and the optical axis AX2′ of the objective lens 212, a distance r3 between the plane P′ and the adhesive 214b is equal to a distance r4 between the plane P′ and the adhesive 214c. In addition, force P3 applied from the lens holder 215 to the objective lens 212 via the adhesive 214b is also equal to force P4 applied from the lens holder 215 to the objective lens 212 via the adhesive 214c. Thus, in FIGS. 10A and 10B, torque (r3 x P3) acting on the left side of the objective lens 212 is equal to torque (r4 x P4) acting on the right side of the objective lens 212. Accordingly, the center of gravity of the torque acting on the objective lens 212 is located on the plane P′, at a position above the rotation axis of the lens holder 215, and thus the vibrational frequency of the lens holder 215 is proximate to the vibrational frequency of the objective lens 212. Thus, if adhesives are applied at the positions as in the comparative example, the vibrational amplitude of the objective lens 212 increases.

FIG. 7A is a diagram illustrating the relation between the adhesion positions according to this embodiment and the rotation of the lens holder, and FIG. 7B is a sectional view along a line VII-VII indicated in FIG. 7A.

If the vibrational frequency of the lens holder 115 is not proximate to the vibrational frequencies of the objective lenses 111 and 112, the above-described resonance problem can be solved. Vibrations transmitted from the lens holder 115 to the objective lenses 111 and 112 travel through two routes, i.e., a route traveling through the adhesives 113a to 113c and 114a to 114c, and a route traveling through the contact portions between the lens holder 115 and the objective lenses 111 and 112. Thus, if the area of the contact portions between the lens holder 115 and the objective lens 111 is small, the influence of the vibration transmitted through the adhesives becomes significant.

It should be noted that, in this embodiment, as shown in FIG. 7A, the adhesives 113a to 113c are applied to positions which are asymmetrical relative to the plane P which includes the rotation axis of the lens holder 115 and the optical axis AX1 of the objective lens 111. Thus, a distance rl from the plane P to each of the adhesives 113b and 113c is different from a distance r2 from the plane P to the adhesive 113a. Thus, in FIGS. 7A and 7B, torque (2 x rl x P1) acting on the left side of the objective lens 111 can be set differently from torque (r2 x P2) acting on the right side of the objective lens 111. Consequently, the center of gravity of torque acting on the objective lens 111 is displaced from the plane P, at a position above the rotation axis of the lens holder 115, and thus proximity between the vibrational frequency of the lens holder 215 and the vibrational frequency of the objective lens 111 can be avoided. Accordingly, application of the adhesives 113a to 113c to the positions as in this embodiment makes it possible to suppress increase in vibrational amplitude of the objective lens 111.

Similarly to the case of the DVD/CD objective lens 111, since the adhesion positions between the BD objective lens 112 and the lens holder 115 are arranged asymmetrically relative to the plane P, it is possible to suppress increase in vibrational amplitude of the objective lens 112.

Further, the protrusions 122a to 122c for supporting the objective lens 111 are arranged on the lens holder 115 to be asymmetrical relative to the plane P. Based on the same principle as in the asymmetrical arrangement of the adhesives 113a to 113c, the vibrational frequency of the objective lens 111 can be set different from the vibrational frequency of the lens holder 115, and thus it is possible to suppress increase in the vibrational amplitude of the objective lens 111.

In this embodiment, the adhesives 113a to 113c which are asymmetrical relative to the plane P, and also the protrusions 122a to 122c which are asymmetrical relative to the plane P are employed in a combined manner thereby to fix the objective lens 111 to the lens holder 115. However, one of either the adhesives or protrusions may be employed. That is, like the way the BD objective lens 112 is fitted, the periphery of the lower surface of the objective lens 111 may be supported by a surface, and the adhesives 113a to 113c may be applied to positions which are asymmetrical relative to the plane P. Alternatively, the periphery of the lower surface of the objective lens 111 may be supported by a plurality of protrusions which are not arranged asymmetrically relative to the plane P, while the adhesives 113a to 113c are applied to positions asymmetrical relative to the plane P. Still alternatively, the adhesives may be applied to positions which are not asymmetrical relative to the plane P, while the protrusions 122a to 122c supporting the objective lens 111 are arranged asymmetrically relative to the plane P. Any of the above-described fitting structures can reduce the influence of resonances as compared to the case where adhesives and materials supporting the objective lens 111 are positioned symmetrical relative to the plane P.

It should be noted that, as in this embodiment, a combination of asymmetrical adhesive application position and asymmetrical protrusion position enables further reduction in the influence of resonances on the objective lens. The DVD/CD objective lens 111 is usually made of resin material, which is less stiff and lighter in weight than glass material, and thus vibration from the lens holder 115 is easily transmitted to the DVC/CD objective lens 111. Accordingly, if the objective lens is made of resin material, it is preferable to fit the objective lens 111 as in this embodiment. The BD objective lens 112 is usually made of glass material, and can be supported by a plane surface as in this embodiment. However, it may be supported by protrusions arranged asymmetrically in the same manner as the objective lens 111.

The present invention is applicable to optical pickups used in optical disk drives.

While the invention has been described in detail, the foregoing description is in all aspects illustrative and not restrictive. It will be understood that numerous other modifications and variations can be devised without departing from the scope of the invention.

1. An optical pickup device comprising:
an objective lens;
a lens holder for retaining the objective lens; and
an actuator for rotating the lens holder to control tilt of the objective lens; wherein
the objective lens is bonded to the lens holder via adhesives applied at a plurality of adhesion positions, and
the adhesion positions at which the objective lens and the lens holder are bonded are asymmetrical relative to a plane which includes the rotation axis of the lens holder and the optical axis of the objective lens.

2. The optical pickup device according to claim 1, wherein the number of the adhesion positions between the objective lens and the lens holder is an odd number.

3. The optical pickup device according to claim 1, wherein the objective lens is made of a resin material.

4. The optical pickup device according to claim 1, wherein:
the lens holder has a plurality of protrusions which are arranged asymmetrically relative to the plane including the rotation axis of the lens holder and the optical axis of the objective lens, and are in contact with the periphery of the lower surface of the objective lens; and
the objective lens is supported by the protrusions and is bonded to the lens holder via the adhesives.

5. The optical pickup device according to claim 1, wherein the adhesion positions at which the objective lens and the lens holder are bonded are arranged at regular intervals in the circumferential direction of the objective lens.

6. An optical pickup device comprising:
a first objective lens;
a second objective lens;
a lens holder for retaining the first objective lens and the second objective lens; and
an actuator for rotating the lens holder to control tilt of the first objective lens and the second objective lens; wherein
the first objective lens and the second objective lens are arranged in line along the rotation axis of the lens holder,
each of the first objective lens and the second objective lens is bonded to the lens holder via adhesives applied at a plurality of adhesion positions,
the adhesion positions at which the first objective lens and the lens holder are bonded are asymmetrical relative to a plane which includes the rotation axis of the lens holder and the optical axis of the first objective lens, and
the adhesion positions at which the first second objective lens and the lens holder are bonded are asymmetrical relative to a plane which includes the rotation axis of the lens holder and the optical axis of the second objective lens.

7. An optical pickup device comprising:
an objective lens;
a lens holder for retaining the objective lens; and
an actuator for rotating the lens holder to control tilt of the objective lens; wherein
the lens holder has a plurality of protrusions which are arranged asymmetrically relative to a plane including the rotation axis of the lens holder and the optical axis of the objective lens, and are in contact with the periphery of the lower surface of the objective lens, and
the objective lens is supported by the protrusions and is bonded to the lens holder via adhesives.

8. The optical pickup device according to claim 7, wherein the number of the protrusions of the lens holder is an odd number.

9. The optical pickup device according to claim 7, wherein the protrusions of the lens holder are arranged at regular intervals in the circumferential direction of each objective lens.
